(19) United States
(12) Patent Application Publication
(10) Pub. No.: US 2025/0128951 A1
(43) Pub. Date: Apr. 24, 2025

(54) PROCESS FOR THE PURIFICATION OF GRAPHITE MATERIAL

(71) Applicant: NOUVEAU MONDE GRAPHITE INC., Saint-Michel-des-Saints (CA)

(72) Inventors: René BOISVERT, Saint-Michel-des-Saints (CA); Patrice BOULANGER, Saint-Michel-des-Saints (CA); Martin BRASSARD, Saint-Michel-des-Saints (CA); Éric DESAULNIERS, Saint-Michel-des-Saints (CA); Graeme NORVAL, Saint-Michel-des-Saints (CA); Philippe RIECKMANN, Saint-Michel-des-Saints (CA); Andrew TAN, North York (CA)

(21) Appl. No.: 18/682,204

(22) PCT Filed: Aug. 10, 2022
(86) PCT No.: PCT/CA2022/051223

§ 371 Date: Feb. 8, 2024

Related U.S. Application Data
(60) Provisional application No. 63/260,116, filed on Aug. 10, 2021.

(51) Int. Cl. C01B 32/215; C01B 9/02; C01B 32/23

(52) U.S. Cl. CPC C01B 32/215; C01B 9/02; C01B 32/23; C01P 2004/32

(57) ABSTRACT

A process for the purification of a graphite material that includes metal sulfide impurities is provided. The process includes subjecting the graphite material to oxidizing conditions, in the presence of oxygen, to convert the metal sulfide impurities into metal oxides and sulfur dioxide, thereby obtaining a metal sulfide-lean graphite material; subjecting the metal sulfide-lean graphite material to carbochlorination, in the presence of chlorine gas, to convert the metal oxides into metal chlorides and obtain a metal chloride-rich graphite material; and purging the metal chlorides from the metal chloride-rich graphite material, thereby obtaining a purified graphite material.

### FIELD

The technical field generally relates to the purification of graphite, and more particularly relates to the purification of graphite containing metal sulfide impurities using oxidation and carbochlorination.

### BACKGROUND

There is growing worldwide demand for high-purity graphite, for use in lithium-ion batteries. This is at least in part due to the increased use and availability of hand-held electronic devices and the emerging electric vehicle market.

Several techniques are known to produce high-purity graphite. For example, one technique uses strong acids such as HF or H₂SO₄ and generate large volumes of toxic effluents which can cause environmental issues, require heavy treatment processes as well as costly workspace safety procedures and equipment. Another known technique is thermal treatment, in which the graphite to be purified is heated to temperatures between about 2500° C. and about 2800° C. Thermal treatments can however be costly to set up and operate, and some impurities may be challenging to remove. Carbochlorination processes have also been developed but have yet to find a large-scale commercial application.

Many challenges still exist in the field of graphite purification.

### SUMMARY

In one aspect of the present description, a process for the purification of a graphite material that includes metal sulfide impurities is provided. The process includes subjecting the graphite material to oxidizing conditions, in the presence of oxygen, to convert the metal sulfide impurities into metal oxides and sulfur dioxide, thereby obtaining a metal sulfide-lean graphite material; subjecting the metal sulfide-lean graphite material to carbochlorination, in the presence of chlorine gas, to convert the metal oxides into metal chlorides and obtain a metal chloride-rich graphite material; and purging the metal chlorides from the metal chloride-rich graphite material, thereby obtaining a purified graphite material.

In another aspect of the present description, a process for the purification of a graphite material that includes metal sulfide impurities is provided. The process includes providing the graphite material in a furnace; subjecting the graphite material to oxidizing conditions, in the presence of oxygen to convert the metallic sulfide impurities into metallic oxides and sulfur dioxide, thereby obtaining a metallic sulfide-lean graphite material; subjecting the metallic sulfide-lean graphite material to carbochlorination, in the presence of chlorine gas, to convert the metallic oxides into metallic chlorides; and displacing the metallic chlorides from the furnace, thereby obtaining a purified graphite material.

### BRIEF DESCRIPTION OF THE FIGURES

FIG. 1 is a process flow diagram of a graphite treatment operation according to an embodiment of the present description, including a graphite purification operation;

FIG. 2 is a diagram representing a system for the treatment of a graphite material according to an embodiment of the present description, more particularly showing pre-treatment steps purification of graphite material in a purification furnace;

FIG. 3 is a diagram representing a system for the treatment of a graphite material according to an embodiment of the present description, more particularly showing purification of graphite material in a purification furnace and post-treatment of off-gases and liquids;

FIG. 4 is a process flow diagram of a graphite purification operation, according to an embodiment of the present description; and

FIG. 5 is a diagram representing a system for the treatment of a graphite material according to another embodiment of the present description.

### DETAILED DESCRIPTION

Various techniques that are described herein enable the treatment of various types of graphite material, and more particularly enable the purification of graphite material that includes metal sulfide impurities.

It is understood that the term “graphite material”, as used herein, generally refers to particulate graphite at various processing stages, to be purified. The particulate graphite to be purified is typically of a lower purity (e.g., less than about 99.95% graphite). The term “graphite material” refers to either artificial or natural graphite and can also include recycled graphite. Non-limiting examples of graphite material include graphite flakes, micronized graphite, spheronized graphite and prismatic graphite. In some embodiments, the graphite material can be selected from the group consisting of natural graphite, artificial graphite, exfoliated graphite, graphene materials and mixtures thereof. The graphite material may be of all sizes. For example, the size of the graphite particles can be from less than 5 μm to more than 1000 μm in diameter or from about 50 μm to about 800 μm in diameter. For example, the graphite particles can have a thickness between about 1 μm and about 150 μm.

It is understood that the term “metal sulfide” refers to compounds that include at least one metal atom/ion and at least one sulfur atom or sulfide ion. The term “metal sulfide” includes “mixed metal sulfides”, wherein the metal sulfide includes at least two metal atoms/ion of different elements and at least one sulfur atom or sulfide ion. Without being limiting, the metal sulfide can include at least one of an iron sulfide, an aluminum sulfide, a copper sulfide, molybdenum disulfide, zinc sulfide, nickel sulfide, manganese sulfide and combinations thereof. For example, the iron sulfide is selected from the group consisting of iron (II) sulfide, greigite, pyrrhotite, troilite, mackinawite, marcasite, pyrite and combinations thereof. For example, the copper sulfide is selected from the group consisting of villamaninite, covellite, yarrowite, spionkopite, geerite, anilite, digenite, roxybyite, djurleite, chalcocite and combinations thereof.

When a Li-ion battery is charged for the first time, the electrolyte decomposes to produce a passivation film called solid electrolyte interface (SEI). This SEI is an ionic conductor but is not an electronic conductor. SEI is an important factor to the performance of the batteries in terms of cycling and calendar life. A High degree of purification of the graphite—to or greater than 99.95% purity—is typically preferred to avoid side reactions between impurities and the electrolyte. The graphite material to be purified of the present description includes metal sulfides impurities. The term “impurities” refers to a minor portion of the total weight of the graphite material. For example, and without being limiting, the graphite material can include at least 90 wt % graphite and 10 wt % impurities, or at least 95 wt % graphite and 5 wt % impurities, or at least 98 wt % graphite and 2 wt % impurities, or at least 99.90 wt % graphite and 0.10 wt % impurities. The metal sulfide impurities typically form a portion of the total impurities present in the graphite material. For example, the graphite material can include impurities such as metal oxides, metal sulfides, water, and/or other impurities. The process for the purification of graphite material of the present description aims at reducing the total wt % of impurities in the graphite material. A purified graphite material for use in a battery typically has a degree of purity of at least 99.95%, that is the impurities make up for at most 0.05 wt % (i.e., at most 500 ppm) of the total weight of the graphite material.

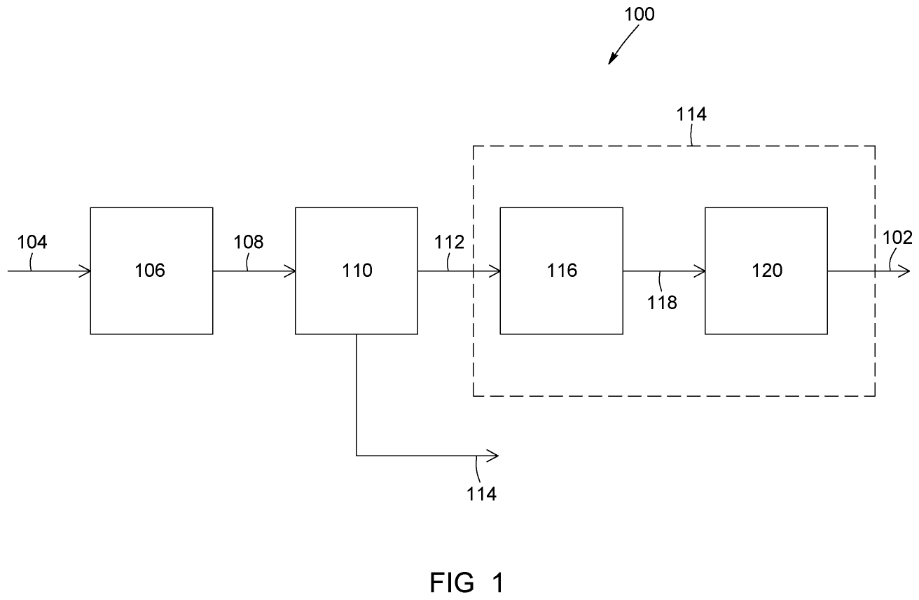

Now referring to FIG. 1, in one aspect of the present description, a process 100 for producing spheronized and purified graphite 102 is provided. In some embodiments, natural graphite ore 104 including metal sulfide impurities, obtained for example as concentrated graphite flakes, is subjected to milling 106 to obtain a milled graphite 108. In some scenarios, the particles of milled graphite 108 can have a mean particle diameter d₅₀ between about 1 μm and about 100 μm, or between about 5 μm and about 50 μm, or between about 10 μm and about 30 μm. The milled graphite 108 is then subjected to a spheronization step 110 to modify the shape of the particles of milled graphite 108 by rounding them. The spheronization step 110 transforms the milled graphite 108 into spheronized graphite 112. Fines graphite particles, or micronized graphite 114 having a smaller mean particle diameter d₅₀ than the spheronized graphite 112 can also be recovered.

Still referring to FIG. 1, the spheronized graphite 112 is subjected to a purification process 114. In the embodiment shown, the purification process 114 is performed on spheronized graphite material 112. It should however be understood that the purification process 114 can be performed directly on the graphite ore 104, on the milled graphite 108, on the spheronized graphite 112, or on any other grade of graphite material, including natural graphite and/or artificial graphite, and including recycled graphite material from used batteries.

In some embodiments, the purification process 114 includes subjecting the spheronized graphite material 112 to an oxidation step 116, in the presence of oxygen, to convert the metal sulfide impurities into metal oxides and sulfur dioxide, thereby obtaining a metal sulfide-lean graphite material 118. The purification process 114 further includes subjecting the metal sulfide-lean graphite material 118 to carbochlorination 120, in the presence of chlorine gas, to convert the metal oxides into metal chlorides. The metal chlorides can then be removed/displaced to obtain a purified graphite material such as the spheronized and purified graphite material 102. The spheronized and purified graphite material 102 can then optionally be further processed. For example, the spheronized and purified graphite material 102 can optionally be coated (e.g., coated with pitch or other types of materials or other surface treatments) to obtain a coated, spheronized and purified graphite material. Embodiments of the purification process and associated system embodiments are described in greater detail herein.

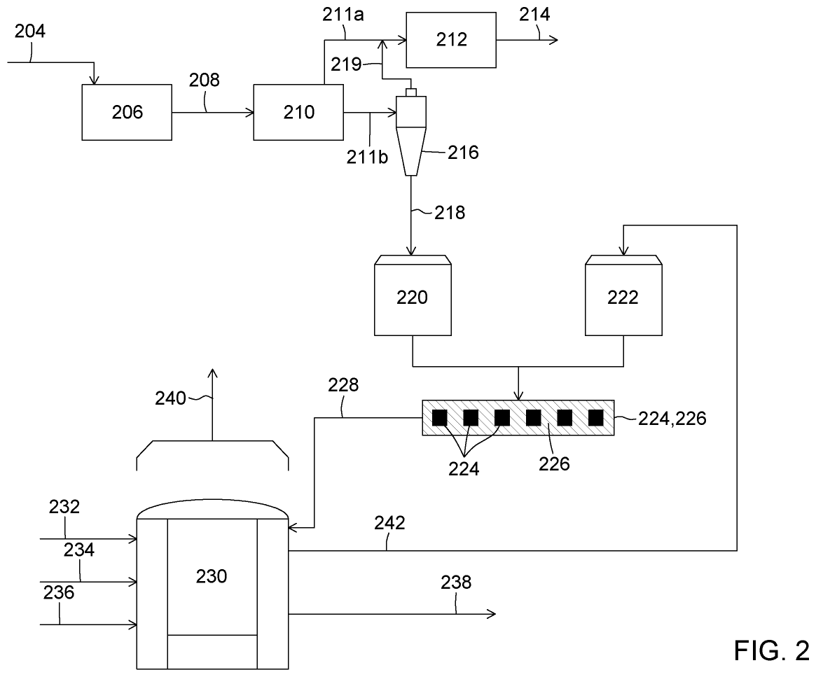

Now referring to FIG. 2, a system for the treatment of graphite material is provided, according to an embodiment of the present description. Concentrated graphite 204, which can be natural graphite obtained from a graphite mine, is fed into milling unit 206 to obtain milled graphite 208. The milled graphite 208 is fed into spheronization unit 210 or a plurality of spheronization units provided in series and/or in parallel, to obtain a fines fraction 211a and a coarse fraction 211b. The fines fraction 211a can be sent to disc collector 212 to remove dust and micronized graphite 214 can be recovered. The coarse fraction 211b can be sent to cyclone 216 to separate spheronized graphite 218 from a secondary fines fraction 219. The secondary fines fraction 219 can be sent back to the fines fraction 211a to pass through dust collector 212. The spheronized graphite 218 can be directly used for further processing and purification or can be stored in spheronized graphite storage 220 for later use or later purification.

It should be understood that the treatment of the coarse fraction 211b and fines faction 211a described herein can be different. For example, in some embodiments, other types of separators could be used instead of the cyclone. In other embodiments, coarse fraction 211b can be directly sent for purification, without further treatment. In other embodiments, fines fraction 211a can be discarded or not subjected to further treatment.

The spheronized graphite 218 can then be placed into crucibles 224 and a filler 222 can be provided to fill the space 226 between the crucibles. In some embodiments, the filler is selected from the group consisting of calcined petroleum coke, metallurgical coke, mesophase carbon and mixture thereof. The arrangement 228 of spheronized graphite-filled crucibles and filler 222 can then be placed into a purification furnace 230 to purify the spheronized graphite material.

In some embodiments, the purification furnace 230 has an oxygen-containing gas inlet 232 (e.g., an air inlet), an inert gas inlet 234 (e.g., an argon inlet) and a chlorine gas inlet 236. In some embodiments, the purification furnace 230 has an inert gas inlet 234 and a chlorine gas inlet 236 but does not have an oxygen-containing gas inlet 232—in such case, the oxidation step can be effected with the oxygen present in the oxygen directly surrounding the graphite material that is to be purified. In some embodiments, the purification furnace 230 has a chlorine gas inlet 236 and does not have an inert gas inlet 234 and/or does not have an oxygen-containing gas inlet 232. In some embodiments, the purification furnace 230 is configured to first subject the spheronized graphite to an oxidation step under the effect of the oxygen-containing gas and to then subject the spheronized graphite to carbochlorination under the effect of the chlorine gas, to obtained a spheronized and purified graphite material 238. The purified and spheronized graphite material 238 can be used or commercialized as is or can be further treated—for example coated—to obtain a coated, spheronized and purified graphite material.

In some embodiments, off-gases 240 can be recovered from the purification furnace 230 and further treated, for example to meet environmental standards. Recycled filler 242 can also be recovered after the spheronized graphite has been purified and sent back to filler storage 222, for reuse. In some embodiments, the purification furnace 230 is selected from the group consisting of an Acheson furnace, a Lengthwise graphitization furnace (LWG), a graphite furnace and an induction furnace. In some embodiments, the purification furnace 230 is an Acheson furnace.

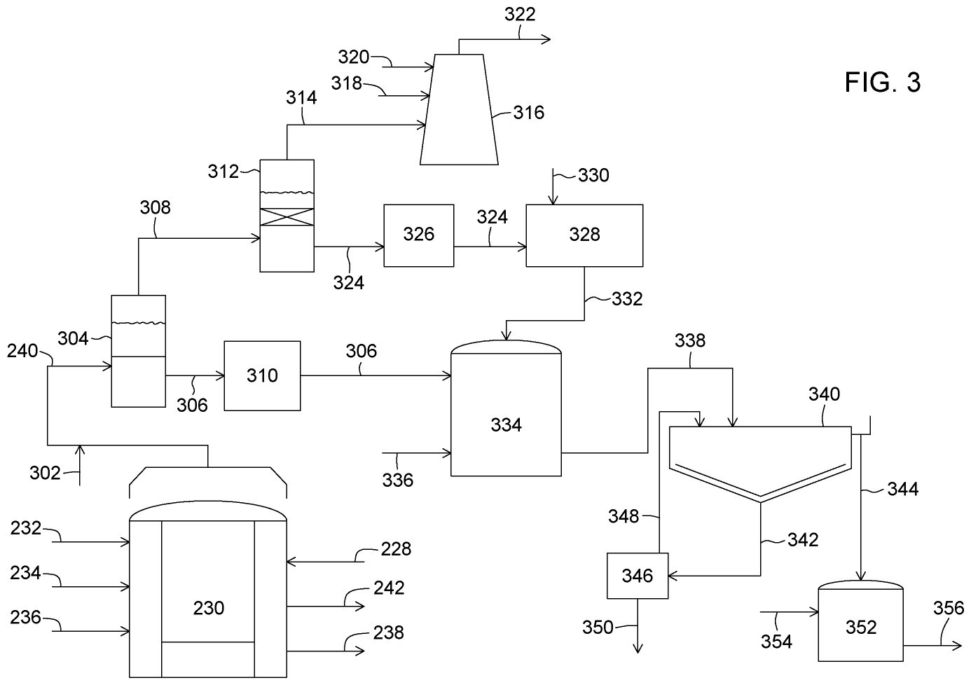

Now referring to FIG. 3, a system for the purification of a graphite material is shown according to an embodiment of the present description, focusing on the post-treatment of off-gases 240 and liquids. Off-gases 240 are collected at an outlet of the purification furnace 230. In some embodiments, off-gases 240 can be diluted with air 302 to be cooled down such that gaseous metal chlorides present in off-gases 240 are condensed. It should be understood that other techniques for cooling down off-gases 240 could be used, such as feeding off-gases 240 into a heat exchanger. The off-gases 240 can be sent to humid scrubber 304. Humid scrubber 304 uses water to react with the metal chlorides and converts the metal chlorides into metal oxides that can be dissolved in water, thereby obtaining metal oxide-rich off-liquids 306 and scrubbed gases 308. The metal oxide-rich off-liquids 306 can be stored in buffer reservoir 310 and further treated. The scrubbed gases 308 are sent to caustic scrubber 312 to remove any remaining chlorine. Off-gases 314 recovered from caustic scrubber 312 are then fed to thermal oxidizer 316 to convert carbon monoxide into carbon dioxide. Air 318 and natural gas 320 are fed to the thermal oxidizer 316 to enable the combustion to take place, and combustion products 322 can be released into the atmosphere or through a CO₂ scrubber. Hypochlorite-rich off-liquids 324 are recovered from caustic scrubber 312 and can be stored in buffer reservoir 326 to be further treated.

The hypochlorite-rich off-liquids 324 can be treated to neutralize the hypochlorite in a hypochlorite-treatment unit, by contacting the hypochlorite-rich off-liquids 324 with a reducing agent 330 such as hydrogen peroxide to create a sodium chloride-rich solution 332. The sodium chloride-rich solution 332 and the metal oxide-rich off-liquids 306 are then fed into water treatment unit 334 to be further treated by addition of a calcium salt solution 336 (such as CaCl₂) and/or Ca(OH)₂ solution). Treated liquid waste 338 can be recovered from the water treatment unit 334 and sent to a clarifier 340. Sludge 342 and effluent 344 are obtained from clarifier 340. The sludge 342 can be sent to a sludge filter 346 to obtain a sludge filtrate 348 that can be recycled back into the clarifier 340, and solid waste 350. The effluent 344 can be stored in effluent reservoir 352 and treated with a strong acid 354 (e.g., H₂SO₄) to obtain neutralized effluent 356.

It should be understood that the steps of milling, spheronization and all the other pre-treatment steps, as well as the off-gas and off-liquid treatments described herein are optional with regard to the purification step performed in the purification furnace.

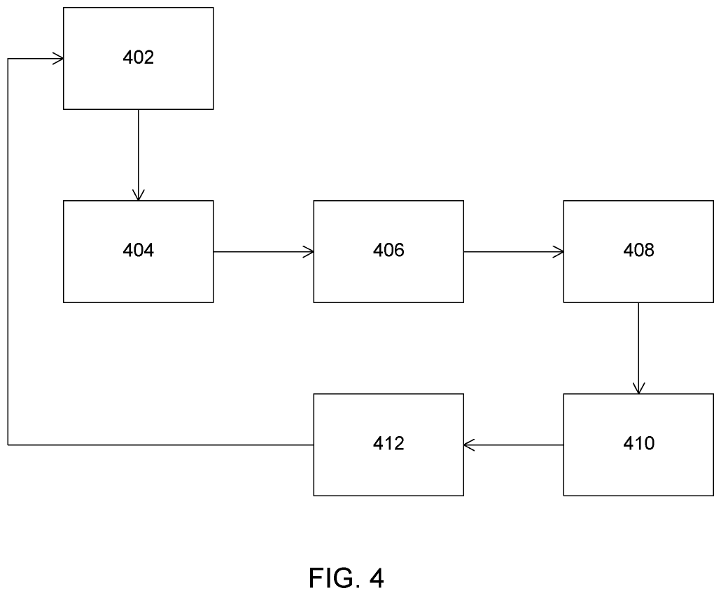

Now turning to FIG. 4, in some embodiments, graphite-filled crucibles are placed in a purification furnace at 402. Calcined petroleum coke can be provided in the empty space between the crucibles. In some embodiments, air is injected at 404, for example between 25 and 300° C., to oxidize metal sulfides into sulfates, metal oxides and sulfur dioxide. In some embodiments, an inert gas purge is performed at 406, for example using argon between 300° C. and 1400° C., to remove the sulfur dioxide obtained from decomposing sulfates and formation of metal oxides. Chlorine gas is then injected into the purification furnace at 408, for example between 1400° C. and 2000° C., or up to 2500° C. The chlorine gas is dispersed through the graphite material and can purify the graphite material to a purity higher than 99.95%. In the purification furnace, the crucibles are used to contain the graphite material and to assist in diffusing the chlorine gas. The purification furnace can be electrically heated. As the chlorine gas diffuses through the graphite material, the chlorine gas reacts with metal oxides to transform the metal oxides into metal chlorides. Metal chlorides have a vaporization temperature that is lower than corresponding metal oxides. A chlorine gas detector can be provided to measure chlorine content in the off-gases, and it can be determined when purification is done as chlorine gas becomes dominant in the off-gases (i.e., when the impurities are consumed and the chlorine gas can no longer react with impurities). In some embodiments, a further inert gas purge is performed at 410 to remove the metal chlorides that are typically gaseous at temperatures between 1400° C. and 2500° C. The spheronized and purified graphite obtained at 412 as well as the calcined petroleum coke can be removed from the purification oven and either further treated, stored, or used as is. New graphite-filled crucibles can then be placed into the purification furnace to restart another purification cycle.

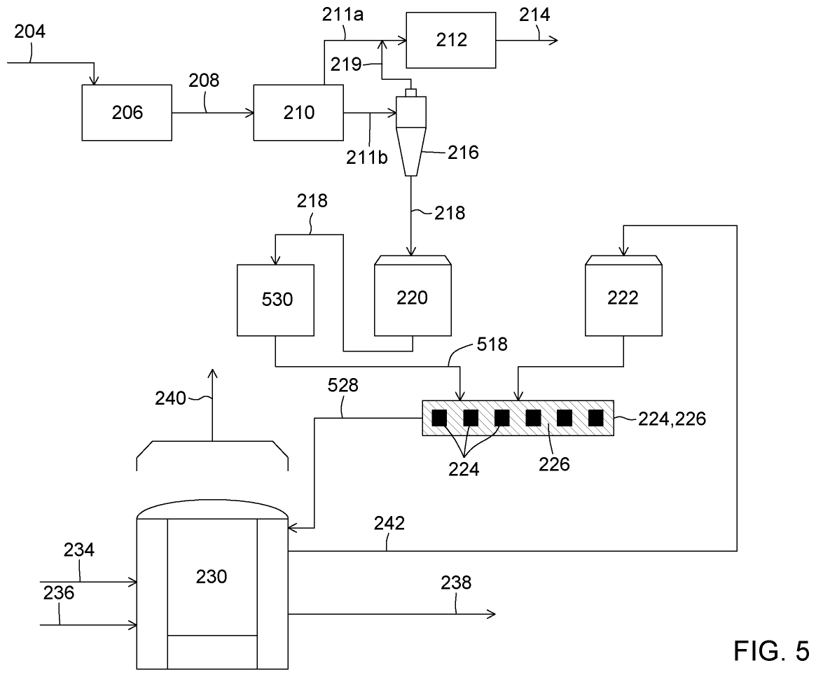

Now turning to FIG. 5, in some embodiments, the spheronized graphite 218 is introduced into a first reactor 530, where the oxidation step is carried out in the presence of oxygen. In some embodiments, the oxidation step that is carried out in the first reactor 530 can be a partial oxidation step, to convert the metal sulfide impurities into metal sulfates. In other embodiments, the oxidation step that is carried out in the first reactor 530 can be a complete oxidation step, to convert the metal sulfide impurities into metal oxides and sulfur dioxide. The material obtained from the first reactor 530 is a pre-treated graphite material 518. The pre-treated graphite material 518 is then introduced into the crucibles 224, with the filler material 222 provided to fill the space 226 between the crucibles 224. The arrangement 528 of pre-treated graphite material-filled crucibles and filler 222 can be placed into the purification furnace 230 to further purify the pre-treated graphite material 518, or the arrangement 528 is already placed into the purification furnace 230 as the pre-treated graphite material 518 is loaded into the crucibles 224. In such case, a chlorine gas inlet 236 and an optional inert gas inlet 234 (e.g., an argon inlet) can be provided to provide chlorine gas and inert gas, respectively, to the furnace 230. In some embodiments, the first reactor 530 can be a kiln, a fluidized bed reactor, a fixed bed reactor or a rotating bed reactor. In some embodiments, the first reactor 530 can be optionally provided with an oxygen-containing gas inlet. In other embodiments, the air contained in the first reactor 530 and inherently in the graphite material to be oxidized is sufficient to allow the removal of the metal sulfide impurities. In some embodiments, the oxidation step in the first reactor 530 is performed at a temperature of 300° C. or lower, for example between 25° C. and 300° C. In such case, the oxidation step carried out in the first reactor 530 is generally a partial oxidation step and the pre-treated graphite material 518 includes metal sulfates. The pre-treated graphite material 518 is then further oxidized in the furnace 230, as the pre-treated graphite material is heated up for the carbochlorination step. In other embodiments, the pre-purification step in the first reactor 530 is performed at a temperature greater than 300° C. to enable complete oxidation of the metal sulfides and convert the metal sulfides into metal oxides and sulfur dioxide. In such case, the material introduced in the furnace 230 can be directly subjected to the carbochlorination step.

It should be understood that the order of the spheronization step, pre-oxidation step and carbochlorination step can vary: In some embodiments, a graphite material (e.g., natural graphite flakes or milled graphite from natural graphite flakes) can first be subjected to a spheronization step, then subjected to an oxidizing step to transform metal sulfide impurities into oxides, and then subjected to a carbochlorination step to transform metal oxide impurities into chlorides. In other embodiments, a graphite material (e.g., natural graphite flakes or milled graphite from natural graphite flakes) can first be subjected to an oxidizing step to transform metal sulfide impurities into oxides, then subjected to a spheronization step, and then subjected to a carbochlorination step to transform metal oxide impurities into chlorides. In yet other embodiments, a graphite material (e.g., natural graphite flakes or milled graphite from natural graphite flakes) can first be subjected to an oxidizing step to transform metal sulfide impurities into oxides, then subjected to a carbochlorination step to transform metal oxide impurities into chlorides and then subjected to a spheronization step.

The graphite purification process described herein is performed on graphite material that includes metal sulfide impurities. Metal sulfides can directly oxidize to metal oxides. For a metal sulfide of general formula MS, the direct formation of metal oxide can generally be expressed as follows:

2 MS₍ₛ₎+3O_{2(g)}→2 MO₍ₛ₎+2 SO₂(g)

Without being limiting, M can for example be iron, copper, molybdenum, zinc, nickel, manganese and combinations thereof.

Metal sulfides can also oxidize through formation of sulfates, which can then decompose to form oxides. These reactions can generally be expressed as follows:

MS₍ₛ₎+2 O_{2(g)}→MSO₄₍ₛ₎

2 MSO₄₍ₛ₎→MOₓ·MSO₄₍ₛ₎+SO_{y(g)}

MOₓ·MSO₄₍ₛ₎→2 MOₓ₍ₛ₎+SO_{y(g)}

It should be understood that injecting air into the purification furnace is performed under suitable conditions so as to enable direct and/or indirect oxidation of metal sulfides to metal oxides. It is also understood that each particular metal sulfide can have its own oxidation pathways.

In a non-limiting example, one of the metal sulfide impurities can be pyrite FeS₂. In the case of pyrite, several chemical reaction pathways can occur—in some cases simultaneously—to obtain iron (III) oxide. The following reaction schemes can for example be observed for the oxidation of pyrite, as explained in J. G. Dunn, Thermochimica Acta, 300, 1997, 127-139, which is hereby incorporated by reference in its entirety.

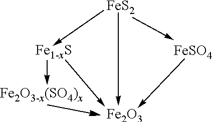

After the metal sulfides are converted into metal oxides, the metal oxides can be exposed to chlorine gas in a carbochlorination step. The carbochlorination reaction can be expressed as follows, and can generally occur at a temperature of 1400° C. or above:

MₓO_{y(s)}+y C₍ₛ₎+Cl_{2(g)}→MxCl_{2(g)}+y CO_{(g)}

In some embodiments, a process for the purification of a graphite material that includes metal sulfide impurities is provided. The process includes:
providing the graphite material in a furnace;
subjecting the graphite material to oxidizing conditions, in the presence of oxygen, to convert the metallic sulfide impurities into metallic oxides and sulfur dioxide, thereby obtaining a metallic sulfide-lean graphite material;
subjecting the metallic sulfide-lean graphite material to carbochlorination, in the presence of chlorine gas, to convert the metallic oxides into metallic chlorides; and
displacing the metallic chlorides from the furnace, thereby obtaining a purified graphite material.

In some embodiments, subjecting the graphite material to oxidizing conditions includes injecting an oxygen-containing gas into the furnace; and heating the furnace to a first temperature that is lower than a decomposition temperature of the metal sulfide impurities. In some embodiments, injecting the oxygen-containing gas includes injecting air. In some embodiments, the oxygen-containing gas is air. The oxygen-containing gas can be injected into the furnace prior to heating the furnace to the first temperature. Alternatively, the oxygen-containing gas can be injected into the furnace as the furnace is heated to the first temperature. The first temperature is selected to be lower than a decomposition temperature of the metal sulfide impurities. In some embodiments, the first temperature is of up to about 300° C. In some embodiments, the first temperature is of less than about 700° C., to avoid decomposition of the graphite. In some embodiments, injecting the oxygen-containing gas into the furnace is halted prior to subjecting the metal sulfide-lean graphite material to carbochlorination.

In some embodiments, the process further includes injecting a first inert gas into the furnace to purge the sulfur dioxide from the furnace prior to subjecting the metal sulfide-lean graphite material to carbochlorination. The first inert gas can for example include at least one of argon and nitrogen. In some embodiments, the process further includes heating the furnace to a second temperature higher than the first temperature, prior to subjecting the metal-sulfide lean graphite material to carbochlorination. For example, the second temperature can be of up to about 1400° C. In some embodiments, the first inert gas is injected into the furnace as the furnace is heated up to the second temperature.

In some embodiments, subjecting the metal sulfide-lean graphite material to carbochlorination includes injecting chlorine gas into the furnace; and heating the furnace to a third temperature that is equal to or higher than the second temperature. In some scenarios, the third temperature can be of at least about 1400° C. In some scenarios, the third temperature is equal to or lower than about 3000° C., or than about 2500° C. In some embodiments, the third temperature is between about 1400° C. and about 2200° C. The carbochlorination reaction generates metal chlorides which are in a gaseous state at the third temperature.

In some embodiments, displacing the metal chlorides from the furnace includes injecting a second inert gas into the furnace to purge the metal chlorides; maintaining the furnace at a temperature at which the metal chlorides are in a gaseous state; and recovering off-gas including the metal chlorides from the furnace. In some embodiments, the process further includes monitoring the concentration of chlorine gas in the furnace off-gases. In some embodiments, the off-gases can be diluted with air to cool the off-gases and condense the metal chlorides.

The following embodiments are among the embodiments provided in the present description:

1. A process for the purification of a graphite material comprising metal sulfide impurities, the process comprising:
providing the graphite material in a furnace;
subjecting the graphite material to oxidizing conditions, in the presence of oxygen, to convert the metal sulfide impurities into metal oxides and sulfur dioxide, thereby obtaining a metal sulfide-lean graphite material;
subjecting the metal sulfide-lean graphite material to carbochlorination, in the presence of chlorine gas, to convert the metal oxides into metal chlorides; and
displacing the metal chlorides from the furnace, thereby obtaining a purified graphite material.

2. The process of embodiment 1, wherein subjecting the graphite material to oxidizing conditions comprises:
injecting an oxygen-containing gas into the furnace; and
heating the furnace to a first temperature that is lower than a decomposition temperature of the metal sulfide impurities.

3. The process of embodiment 2, wherein injecting the oxygen-containing gas into the furnace comprises injecting air into the furnace.

4. The process of embodiment 2 or 3, wherein injecting the oxygen-containing gas into the furnace is performed prior to and/or as the furnace is heated to the first temperature.

5. The process of any one of embodiments 2 to 4, wherein the first temperature is equal to or less than 700° C.

6. The process of any one of embodiments 2 to 5, wherein the first temperature is equal to or less than 300° C.

7. The process of any one of embodiments 2 to 6, wherein injecting the oxygen-containing gas into the furnace is halted prior to subjecting the metal sulfide-lean graphite material to carbochlorination.

8. The process of any one of embodiments 1 to 7, further comprising injecting a first inert gas into the furnace to purge the sulfur dioxide from the furnace prior to subjecting the metal sulfide-lean graphite material to carbochlorination.

9. The process of any one of embodiments 1 to 8, further comprising heating the furnace to a second temperature higher than the first temperature, prior to subjecting the metal sulfide-lean graphite material to carbochlorination.

10. The process of embodiment 9, wherein the second temperature is of up to about 1400° C.

11. The process of any one of embodiments 1 to 10, wherein subjecting the metal sulfide-lean graphite material to carbochlorination comprises:
injecting chlorine gas into the furnace; and
heating the furnace to a third temperature that is equal to or higher than the second temperature.

12. The process of embodiment 11, wherein the third temperature is of at least about 1400° C.

13. The process of embodiment 11 or 12, wherein the third temperature is equal to or lower than about 3000° C.

14. The process of embodiment 11 or 12, wherein the third temperature is equal to or lower than about 2500° C.

15. The process of any one of embodiments 11 to 14, wherein the third temperature is between about 1400° C. and about 2200° C.

16. The process of any one of embodiments 1 to 15, wherein displacing the metal chlorides from the furnace comprises:
injecting a second inert gas into the furnace to purge the metal chlorides;
maintaining the furnace at a temperature at which the metal chlorides are in a gaseous state; and
recovering outlet gas comprising the metal chlorides from the furnace.

17. The process of embodiment 16, further comprising monitoring chlorine gas concentration in off-gases from the furnace.

18. The process of embodiment 16 or 17, further comprising diluting the outlet gas comprising the metal chlorides with air, thereby cooling the outlet gas and condensing the metal chlorides.

19. The process of any one of embodiments 1 to 18, wherein providing the graphite material in the furnace comprises providing the graphite material in crucibles and placing the crucibles into the furnace.

20. The process of embodiment 19, further comprising providing a filler selected from the group consisting of calcined petroleum coke, metallurgical coke, mesophase carbon and mixtures thereof, in free space between the crucibles.

21. The process of any one of embodiments 1 to 20, wherein the graphite material is selected from the group consisting of natural graphite, artificial graphite, exfoliated graphite, graphene materials and mixtures thereof.

22. The process of embodiment 21, wherein the graphite material is a recycled graphite material.

23. The process of any one of embodiments 1 to 22, wherein the graphite material is a spheronized graphite material and the purified graphite material is a spheronized and purified graphite material.

24. The process of any one of embodiments 1 to 22, wherein the graphite material is a prismatic graphite material and the purified graphite material is a prismatic and purified graphite material.

25. The process of any one of embodiments 1 to 24, wherein the metal sulfide impurities comprise at least one of an iron sulfide, a copper sulfide, molybdenum sulfide, zinc sulfide, nickel sulfide, manganese sulfide and combinations thereof.

26. The process of any one of embodiments 1 to 25, wherein the furnace is selected from the group consisting of an Acheson furnace, a Lenghtwise graphitization furnace (LWG), a graphite furnace and an induction furnace.

27. A process for the purification of a graphite material comprising metal sulfide impurities, the process comprising:
subjecting the graphite material to oxidizing conditions, in the presence of oxygen, to convert the metal sulfide impurities into metal oxides and sulfur dioxide, thereby obtaining a metal sulfide-lean graphite material;
subjecting the metal sulfide-lean graphite material to carbochlorination, in the presence of chlorine gas, to convert the metal oxides into metal chlorides and obtain a metal chloride-rich graphite material; and
purging the metal chlorides from the metal chloride-rich graphite material, thereby obtaining a purified graphite material.

28. The process of embodiment 27, wherein subjecting the graphite material to oxidizing conditions is performed at a first temperature that is lower than a decomposition temperature of the metal sulfide impurities.

29. The process of embodiment 28, wherein the first temperature is equal to or less than 700° C.

30. The process of embodiment 28 or 29, wherein the first temperature is equal to or less than 500° C.

31. The process of any one of embodiments 28 to 30, wherein the first temperature is equal to or less than 300° C.

32. The process of any one of embodiments 27 to 31, further comprising purging the sulfur dioxide from the metal sulfide-lean material prior to subjecting the metal sulfide-lean graphite material to carbochlorination.

33. The process of embodiment 32, wherein purging the sulfur dioxide from the metal sulfide-lean material comprises purging the sulfur dioxide with a first inert gas.

34. The process of any one of embodiments 27 to 33, further comprising heating the metal sulfide-lean graphite material to a second temperature equal to or higher than the first temperature, prior to subjecting the metal sulfide-lean graphite material to carbochlorination.

35. The process of embodiment 34, wherein the second temperature is of up to about 1400° C.

36. The process of embodiment 34, wherein the second temperature is between about 300° C. and about 1000° C.

37. The process of embodiment 34, wherein the second temperature is between about 500° C. and about 700° C.

38. The process of any one of embodiments 27 to 37, wherein subjecting the metal sulfide-lean graphite material to carbochlorination comprises heating the metal sulfide-lean graphite material to a third temperature that is equal to or higher than the second temperature.

39. The process of embodiment 38, wherein the third temperature is of at least about 1400° C.

40. The process of embodiment 38 or 39, wherein the third temperature is equal to or lower than about 3000° C.

41. The process of embodiment 38 or 39, wherein the third temperature is equal to or lower than about 2500° C.

42. The process of any one of embodiments 38 to 41, wherein the third temperature is between about 1400° C. and about 2200° C.

43. The process of any one of embodiments 27 to 42, wherein purging the metal chlorides from the metal chloride-rich graphite material comprises:
purging with a second inert gas;
maintaining the metal chloride-rich graphite material at a temperature at which the metal chlorides are in a gaseous state; and
recovering outlet gas comprising the metal chlorides.

44. The process of embodiment 43, further comprising monitoring chlorine gas concentration in off-gases.

45. The process of embodiment 43 or 44, further comprising diluting the outlet gas comprising the metal chlorides with air, thereby cooling the outlet gas and condensing the metal chlorides.

46. The process of any one of embodiments 27 to 45, wherein subjecting the graphite material to oxidizing conditions and subjecting the metal sulfide-lean graphite material to carbochlorination are performed in a single reactor.

47. The process of any one of embodiments 27 to 46, wherein subjecting the graphite material to oxidizing conditions is performed in a first reactor and subjecting the metal sulfide-lean graphite material to carbochlorination is performed in a second reactor.

48. The process of embodiment 47, further comprising placing the metal sulfide-lean graphite material in crucibles and placing the crucibles into the second reactor.

49. The process of embodiment 48, further comprising providing a filler selected from the group consisting of calcined petroleum coke, metallurgical coke, mesophase carbon and mixtures thereof, in free space between the crucibles.

50. The process of any one of embodiments 27 to 49, wherein the graphite material is selected from the group consisting of natural graphite, artificial graphite, exfoliated graphite, graphene materials and mixtures thereof.

51. The process of embodiment 50, wherein the graphite material is a recycled graphite material.

52. The process of any one of embodiments 27 to 51, wherein the graphite material is a spheronized graphite material and the purified graphite material is a spheronized and purified graphite material.

53. The process of any one of embodiments 27 to 51, wherein the graphite material is a prismatic graphite material and the purified graphite material is a prismatic and purified graphite material.

54. The process of any one of embodiments 27 to 53, wherein the metal sulfide impurities comprise at least one of an iron sulfide, a copper sulfide, molybdenum disulfide, zinc sulfide, nickel sulfide, manganese sulfide and combinations thereof.

55. The process of any one of embodiments 27 to 54, wherein the first reactor is selected from the group consisting of kiln, a fluidized bed reactor, a fixed bed reactor and a rotating bed reactor.

56. The process of any one of embodiments 27 to 55, wherein the second reactor is selected from the group consisting of an Acheson furnace, a Lenghtwise graphitization furnace (LWG), a graphite furnace and an induction furnace.

57. A process for the purification of a graphite material comprising metal sulfide impurities, the process comprising:
subjecting the graphite material to oxidizing conditions, in the presence of oxygen, to convert the metal sulfide impurities into metal oxides and sulfur dioxide, thereby obtaining a metal sulfide-lean graphite material;
subjecting the metal sulfide-lean graphite material to carbochlorination, in the presence of chlorine gas, to convert the metal oxides into metal chlorides and obtain a metal chloride-rich graphite material; and
purging the metal chlorides from the metal chloride-rich graphite material, thereby obtaining a purified graphite material.

58. The process of embodiment 57, wherein subjecting the graphite material to oxidizing conditions comprises:
a first oxidation step performed at a first temperature that is lower than a decomposition temperature of the metal sulfide impurities, to convert the metal sulfide impurities into metal sulfates and obtain a pre-treated graphite material; and
a second oxidation step performed on the pre-treated graphite material at a second temperature that is higher than the first temperature, to convert the metal sulfates into metal oxides and sulfur dioxide and obtain the metal sulfide-lean graphite material.

59. The process of embodiment 58, wherein the first oxidation step is performed in a first reactor; and the second oxidation step, subjecting the metal sulfide-lean graphite material to carbochlorination and purging the metal chlorides is performed in a second reactor.

60. The process of embodiment 58 or 59, wherein the first temperature is equal to or less than 300° C.

61. The process of embodiment 58 or 59, wherein the first temperature is between about 25° C. and about 300° C.

62. The process of any one of embodiments 58 to 61, wherein the second temperature is of up to about 1400° C.

63. The process of any one of embodiments 58 to 61, wherein the second temperature is between about 300° C. and about 1000° C.

64. The process of any one of embodiments 58 to 61, wherein the second temperature is between about 500° C. and about 700° C.

65. The process of any one of embodiments 57 to 64, further comprising purging the sulfur dioxide from the metal sulfide-lean material prior to subjecting the metal sulfide-lean graphite material to carbochlorination.

66. The process of embodiment 65, wherein purging the sulfur dioxide from the metal sulfide-lean material comprises purging the sulfur dioxide with a first inert gas.

67. The process of any one of embodiments 57 to 66, wherein the second oxidation step is performed prior to subjecting the metal sulfide-lean graphite material to carbochlorination.

68. The process of any one of embodiments 57 to 67, wherein subjecting the metal sulfide-lean graphite material to carbochlorination comprises heating the metal sulfide-lean graphite material to a third temperature that is equal to or higher than the second temperature.

69. The process of embodiment 68, wherein the third temperature is of at least about 1400° C.

70. The process of embodiment 68 or 69, wherein the third temperature is equal to or lower than about 3000° C.

71. The process of embodiment 68 or 69, wherein the third temperature is equal to or lower than about 2500° C.

72. The process of any one of embodiments 68 to 71, wherein the third temperature is between about 1400° C. and about 2200° C.

73. The process of any one of embodiments 57 to 72, wherein purging the metal chlorides from the metal chloride-rich graphite material comprises:
purging with a second inert gas;
maintaining the metal chloride-rich graphite material at a temperature at which the metal chlorides are in a gaseous state; and
recovering outlet gas comprising the metal chlorides.

74. The process of embodiment 73, further comprising monitoring chlorine gas concentration in off-gases.

75. The process of embodiment 73 or 74, further comprising diluting the outlet gas comprising the metal chlorides with air, thereby cooling the outlet gas and condensing the metal chlorides.

76. The process of any one of embodiments 57 to 75, further comprising placing the pre-treated graphite material in crucibles and placing the crucibles into the second reactor, or placing the pre-treated graphite material in crucibles that are provided in the second reactor.

77. The process of embodiment 76, further comprising providing a filler selected from the group consisting of calcined petroleum coke, metallurgical coke, mesophase carbon and mixtures thereof, in free space between the crucibles.

78. The process of any one of embodiments 57 to 77, wherein the graphite material is selected from the group consisting of natural graphite, artificial graphite, exfoliated graphite, graphene materials and mixtures thereof.

79. The process of embodiment 78, wherein the graphite material is natural graphite flakes or is obtained from natural graphite flakes.

80. The process of embodiment 78, wherein the graphite material is a recycled graphite material.

81. The process of any one of embodiments 57 to 80, wherein the graphite material is a spheronized graphite material and the purified graphite material is a spheronized and purified graphite material.

82. The process of any one of embodiments 57 to 80, wherein the graphite material is a prismatic graphite material and the purified graphite material is a prismatic and purified graphite material.

83. The process of any one of embodiments 57 to 82, wherein the metal sulfide impurities comprise at least one of an iron sulfide, a copper sulfide, molybdenum sulfide, zinc sulfide, nickel sulfide, manganese sulfide and combinations thereof.

84. The process of any one of embodiments 57 to 83, wherein the first reactor is selected from the group consisting of kiln, a fluidized bed reactor, a fixed bed reactor and a rotating bed reactor.

85. The process of any one of embodiments 57 to 84, wherein the second reactor is selected from the group consisting of an Acheson furnace, a Lenghtwise graphitization furnace (LWG), a graphite furnace, a fluidized bed reactor, an electrothermal reactor, and an induction furnace.

It should be noted that the techniques described herein can be used to purify graphite material that include metal sulfide impurities. The purification can be used on several types of graphite materials, such as natural or artificial graphite materials, or on recycled graphite materials from used batteries. Several alternative embodiments and examples have been described and illustrated herein. The embodiments described herein are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind.

1. A process for the purification of a graphite material comprising metal sulfide impurities, the process comprising:
subjecting the graphite material to oxidizing conditions, in the presence of oxygen, to convert the metal sulfide impurities into metal oxides and sulfur dioxide, thereby obtaining a metal sulfide-lean graphite material;
subjecting the metal sulfide-lean graphite material to carbochlorination, in the presence of chlorine gas, to convert the metal oxides into metal chlorides and obtain a metal chloride-rich graphite material; and
purging the metal chlorides from the metal chloride-rich graphite material, thereby obtaining a purified graphite material.

2. The process of claim 1, wherein subjecting the graphite material to oxidizing conditions comprises:
a first oxidation step performed at a first temperature that is lower than a decomposition temperature of the metal sulfide impurities, to convert the metal sulfide impurities into metal sulfates and obtain a pre-treated graphite material; and
a second oxidation step performed on the pre-treated graphite material at a second temperature that is higher than the first temperature, to convert the metal sulfates into metal oxides and sulfur dioxide and obtain the metal sulfide-lean graphite material.

3. The process of claim 2, wherein the first oxidation step is performed in a first reactor; and the second oxidation step, subjecting the metal sulfide-lean graphite material to carbochlorination and purging the metal chlorides is performed in a second reactor.

4. The process of claim 2 or 3, wherein the first temperature is equal to or less than 300° C.

5. The process of claim 2 or 3, wherein the first temperature is between about 25° C. and about 300° C.

6. The process of any one of claims 2 to 5, wherein the second temperature is of up to about 1400° C.

7. The process of any one of claims 2 to 5, wherein the second temperature is between about 300° C. and about 1000° C.

8. The process of any one of claims 2 to 5, wherein the second temperature is between about 500° C. and about 700° C.

9. The process of any one of claims 1 to 8, further comprising purging the sulfur dioxide from the metal sulfide-lean material prior to subjecting the metal sulfide-lean graphite material to carbochlorination.

10. The process of claim 9, wherein purging the sulfur dioxide from the metal sulfide-lean material comprises purging the sulfur dioxide with a first inert gas.

11. The process of any one of claims 1 to 10, wherein the second oxidation step is performed prior to subjecting the metal sulfide-lean graphite material to carbochlorination.

12. The process of any one of claims 1 to 11, wherein subjecting the metal sulfide-lean graphite material to carbochlorination comprises heating the metal sulfide-lean graphite material to a third temperature that is equal to or higher than the second temperature.

13. The process of claim 12, wherein the third temperature is of at least about 1400° C.

14. The process of claim 12 or 13, wherein the third temperature is equal to or lower than about 3000° C.

15. The process of claim 12 or 13, wherein the third temperature is equal to or lower than about 2500° C.

16. The process of any one of claims 12 to 15, wherein the third temperature is between about 1400° C. and about 2200° C.

17. The process of any one of claims 1 to 16, wherein purging the metal chlorides from the metal chloride-rich graphite material comprises:
purging with a second inert gas;
maintaining the metal chloride-rich graphite material at a temperature at which the metal chlorides are in a gaseous state; and
recovering outlet gas comprising the metal chlorides.

18. The process of claim 17, further comprising monitoring chlorine gas concentration in off-gases.

19. The process of claim 17 or 18, further comprising diluting the outlet gas comprising the metal chlorides with air, thereby cooling the outlet gas and condensing the metal chlorides.

20. The process of any one of claims 1 to 19, further comprising placing the pre-treated graphite material in crucibles and placing the crucibles into the second reactor, or placing the pre-treated graphite material in crucibles that are provided in the second reactor.

21. The process of claim 20, further comprising providing a filler selected from the group consisting of calcined petroleum coke, metallurgical coke, mesophase carbon and mixtures thereof, in free space between the crucibles.

22. The process of any one of claims 1 to 21, wherein the graphite material is selected from the group consisting of natural graphite, artificial graphite, exfoliated graphite, graphene materials and mixtures thereof.

23. The process of claim 22, wherein the graphite material is natural graphite flakes or is obtained from natural graphite flakes.

24. The process of claim 22, wherein the graphite material is a recycled graphite material.

25. The process of any one of claims 1 to 24, wherein the graphite material is a spheronized graphite material and the purified graphite material is a spheronized and purified graphite material.

26. The process of any one of claims 1 to 24, wherein the graphite material is a prismatic graphite material and the purified graphite material is a prismatic and purified graphite material.

27. The process of any one of claims 1 to 26, wherein the metal sulfide impurities comprise at least one of an iron sulfide, a copper sulfide, molybdenum sulfide, zinc sulfide, nickel sulfide, manganese sulfide and combinations thereof.

28. The process of any one of claims 1 to 27, wherein the first reactor is selected from the group consisting of kiln, a fluidized bed reactor, a fixed bed reactor and a rotating bed reactor.

29. The process of any one of claims 1 to 28, wherein the second reactor is selected from the group consisting of an Acheson furnace, a Lenghtwise graphitization furnace (LWG), a graphite furnace, a fluidized bed reactor, an electrothermal reactor, and an induction furnace.
